(19) United States
(12) Patent Application Publication
(10) Pub. No.: US 2021/0097500 A1
(43) Pub. Date: Apr. 1, 2021

(54) AUTOMATIC DETECTION OF SOCIAL GROUP ACTIVITIES AND EVENTS AND PARTICIPATION THEREIN

(71) Applicant: Wells Fargo Bank, N.A., San Francisco, CA (US)

(72) Inventors: Kara Leigh Bellovich, Richmond Heights, MO (US); Shawn Stuart Eldridge, Eureka, MO (US); Devin Marcus DeStefano, Creve Coeur, MO (US); Scott Welz, Kirkwood, MO (US)

(21) Appl. No.: 15/383,459

(22) Filed: Dec. 19, 2016

(51) Int. Cl. G06Q 10/10; H04L 29/08

(52) U.S. Cl. CPC G06Q 10/1095; G06Q 50/01; H04L 67/22

(57) ABSTRACT

A system, method, and computer media are provided for detecting and responding to a person at or likely to attend and event. The method may comprise receiving, at a network interface of a computer-based system, event information related to an occurrence of an event, determining, using a processor of the computer-based system, an existence, location, and timing of an event based on the received event information. The method may detect, using the processor, a first person attending the event to create person-event data. First person information related to the person-event data may then be transmitted to a communication device of a second person over the network interface. The method may include generating information related to a response activity having a response activity location based on the event location, and then transmitting, to a communication device of the first person over the network interface, an invitation to the response activity.

### TECHNICAL FIELD

Embodiments described herein generally relate to detecting an existence of an event or social group activity, and participation by individuals therein, for example and without limitation, activities by clients associated with an agent of an entity.

### BACKGROUND

Knowledge of a first person attending an event or social activity may permit a second person having a relationship with that person to arrange a meeting or another event with the first person. However, the ability to detect such events or social activities and the presence of the first person at the event has been limited by access to information.

### BRIEF DESCRIPTION OF THE DRAWINGS

In the drawings, which are not necessarily drawn to scale, like numerals may describe similar components in different views. Like numerals having different letter or numeric suffixes may represent different instances of similar components. The drawings illustrate generally, by way of example, but not by way of limitation, various embodiments discussed in the present document.

FIG. 1 is a block diagram illustrating a machine that may be a computer on which various processes described herein may be performed.

FIG. 2 is a block diagram of a distributed computing system.

FIG. 3 is a block diagram of an example of a system for automatic detection of social group activities or events.

FIG. 4 is a flowchart of an example of a process for automatic detection of social group activities or events.

### DETAILED DESCRIPTION

For traditional business interactions in which an advisor provides business services and advice to one or more clients, it is well established that maintaining advisor-client contact in natural settings (e.g., in social activities outside of the normal business relationship) may often provide significant benefits to both the advisor and the client. However, formally scheduling such meetings using traditional tools, and even using evolving social media tools, do not optimize the possibilities for meet ups.

The system described herein provides, among other benefits, an advantageous expansion to the ability to create beneficial meet-ups by utilizing client-related information, with permission, so that, for example, business relationships may be advanced. A business entity having access to certain client information may be able to use that information to enable meetings and get-togethers that are not necessarily prearranged and do not require a formal commitment on the part of a client in advance. Such meetings may be set up either prior to an event, based on information known in advance, or during an event, based on information gathered in real time. It may be more efficient to arrange meetings for an event when multiple clients are in attendance.

Various systems disclosed herein may collect information about an event via publicly available network-enabled channels, such as Facebook, Twitter, news feeds, etc., and also via privately available channels, such as clients' purchases, etc. The system may identify events at which multiple clients are participating, for purposes of, e.g., arranging meetings. The system may examine client data to determine that multiple clients are participating or are likely to participate in the event. The system may then alert advisors of the clients present or planning to go to the event. The advisors may then consider going to the event, and may plan a social gathering at the event, inviting the clients that will be present. Advisors may configure the system to provide an alert when a threshold number or value of clients will be attending the same event, or provide an alert based on some other criteria.

The discussion herein presumes a special or established relationship between and the provider (and also advisor) and its client. However, it is also possible to consider there to be a special relationship with a prospective client as well—according to some criteria that may be used for determining who constitutes a prospective client. For the sake of brevity, any use of the word “client” herein may also apply to prospective clients as well.

Based on the above, disclosed herein is a computer-implemented method for detecting and responding to a person at or likely to attend and event. The method may comprise receiving, at a network interface of a computer-based system, event information related to an occurrence of an event, processing, using a processor of the computer-based system, and storing, in a memory of the computer-based system, the event information. The method may automatically detect, using the processor, a first person at or likely to attend the event to create person-event data. First person information related to the person-event data may then be transmitted to a communication device of a second person over the network interface. The method may then involve generating response activity information related to a response activity having a response activity location based on an event location, and then transmitting, to a communication device of the first person over the network interface, an invitation to the response activity.

A non-transitory computer-readable storage medium may be provided that includes instructions that, when executed by a computer, cause the computer to perform operations of the method described above.

Disclosed herein is also a system comprising a hardware processor, a network interface connected to the hardware processor that is connected to a network via which information related to events, clients, and advisors is communicated. The system may also comprise a non-volatile memory connected to the hardware processor and the network interface comprising event data and client data, and a memory with instructions executable by the processor. Collectively, the processor and memory with instructions may comprise a receiver at which the network interface receives event information related to an occurrence of an event, an event processing component that processes and stores the event information, and a client participation detection and evaluation component that automatically detects a first person at or likely to attend the event to create person-event data that is stored in the memory. The system may further comprise a transmitter that transmits, to a communication device of a second person over the network interface, first person information related to the person-event data and a response activity component that generates response activity information related to a response activity having a response activity location based on an event location.

The transmitter may be configured to transmit, to a communication device of the first person over the network interface, an invitation to the response activity.

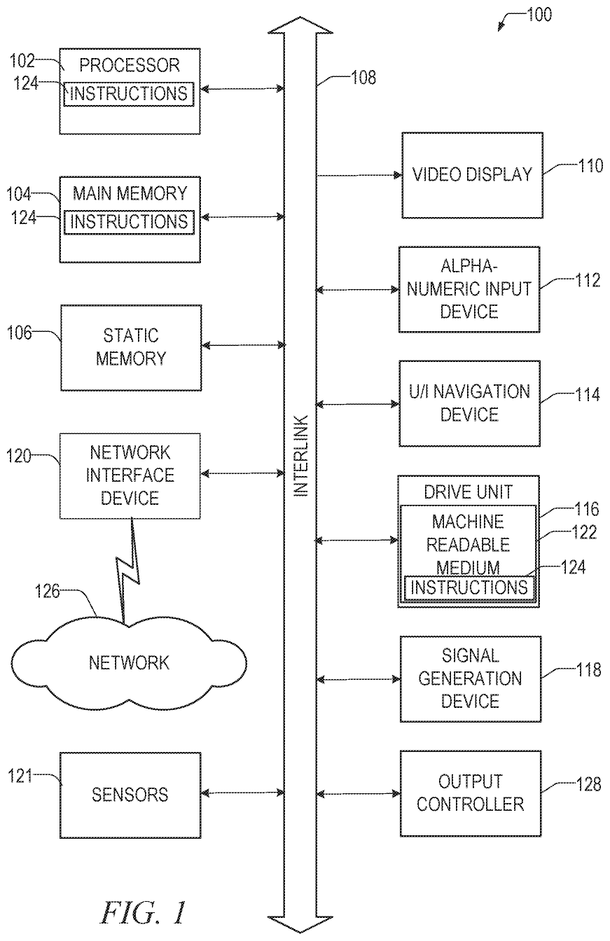

To describe some configurations in greater detail, reference is first made to examples of hardware structures and interconnections usable in the designs of the present disclosure. FIG. 1 is a block diagram illustrating an example of a machine 100 that may be a computer or computing device upon which one or more of the techniques (e.g., methodologies) discussed herein may be performed. In alternative embodiments, the machine 100 may operate as a standalone device or may be connected (e.g., networked) to other machines. In a networked deployment, the machine 100 may operate in the capacity of a server machine, a client machine, or both in server-client network environments. In an example of a machine described herein, the machine 100 may act as a peer machine in peer-to-peer (P2P) (or other distributed) network environment. The machine 100 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Machine 100 may function as a mail user agent (MUA), mail transfer agent (MTA), computing device executing a mobile wallet application, domain name server (DNS), certification authority (CA), public key system (PKS), Key Manager, Key Keeper, or the like. Further, while only a single machine is illustrated, the term “machine” may also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules may include tangible entities (e.g., hardware) capable of performing specified operations and may be configured or arranged in a certain manner. The modules may further comprise software that enables the hardware to perform in a specific manner. In an example, circuits may be arranged (e.g., internally or with respect to external entities such as other circuits) in a specified manner as a module. In an example as described herein, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example as described herein, the software, when executed by the underlying hardware of the module, causes the hardware to perform the specified operations.

Accordingly, the term “module” is understood to encompass a tangible entity, and that entity may be one that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 100 may include a hardware processor 102 (e.g., a central processing unit (CPU), a graphics processing unit (GPU), a hardware processor core, or any combination thereof), a main memory 104 and a static memory 106, some or all of which may communicate with each other via an interlink (e.g., bus) 108. The machine 100 may further include a display unit 110, an alphanumeric input device 112 (e.g., a keyboard), and a user interface (UI) navigation device 114 (e.g., a mouse). In an example described herein, the display unit 110, input device 112 and UI navigation device 114 may be a touch screen display. The machine 100 may additionally include a storage device (e.g., drive unit) 116, a signal generation device 118 (e.g., a speaker), a network interface device 120, and one or more sensors 121, such as a global positioning system (GPS) sensor, compass, accelerometer, or other sensor. The machine 100 may include an output controller 128, such as a serial (e.g., universal serial bus (USB)), parallel, or other wired or wireless (e.g., infrared (IR), near field communication (NFC), etc.) controller connection to communicate or control one or more peripheral devices (e.g., a printer, card reader, etc.).

The storage device 116 may include a machine readable medium 122 on which is stored one or more sets of data structures or instructions 124 (e.g., software) embodying or utilized by any one or more of the techniques or functions described herein. The instructions 124 may also reside, completely or at least partially, within the main memory 104, within static memory 106, or within the hardware processor 102 during execution thereof by the machine 100. In an example, one or any combination of the hardware processor 102, the main memory 104, the static memory 106, or the storage device 116 may constitute machine readable media.

While the machine readable medium 122 is illustrated as a single medium, the term “machine readable medium” may include a single medium or multiple media (e.g., a centralized or distributed database, and/or associated caches and servers) configured to store the one or more instructions 124.

The term “machine readable medium” may include any medium that is capable of storing, encoding, or carrying instructions for execution by the machine 100 and that cause the machine 100 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 124 may further be transmitted or received over a communications network 126 using a transmission medium via the network interface device 120. The term “transmission medium” is defined herein to include any medium that is capable of storing, encoding, or carrying instructions for execution by the machine, and includes digital or analog communications signals or other medium to facilitate communication of such software.

The machine 100 may communicate with one or more other machines 100 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, virtual private networks (VPN), or any other way of transferring data between machines 100. In an example, the network interface device 120 may include one or more physical jacks (e.g., Ethernet, coaxial, or phone jacks) or one or more antennas to connect to the communications network 126.

In an example, the network interface device 120 may include a plurality of antennas to wirelessly communicate using at least one of single-input multiple-output (SIMO), multiple-input multiple-output (MIMO), or multiple-input single-output (MISO) techniques. In some examples, the network interface device 120 may wirelessly communicate using Multiple User MIMO techniques.

A wide variety of computing devices may constitute a machine 100, as described herein. The following list includes a variety of devices that may fit the definition of a machine 100: a personal data assistant (PDA), a cellular telephone, including a smartphone, a tablet computing device, a laptop computer, a desktop computer, a workstation, a server computer, a mainframe computer, and the like.

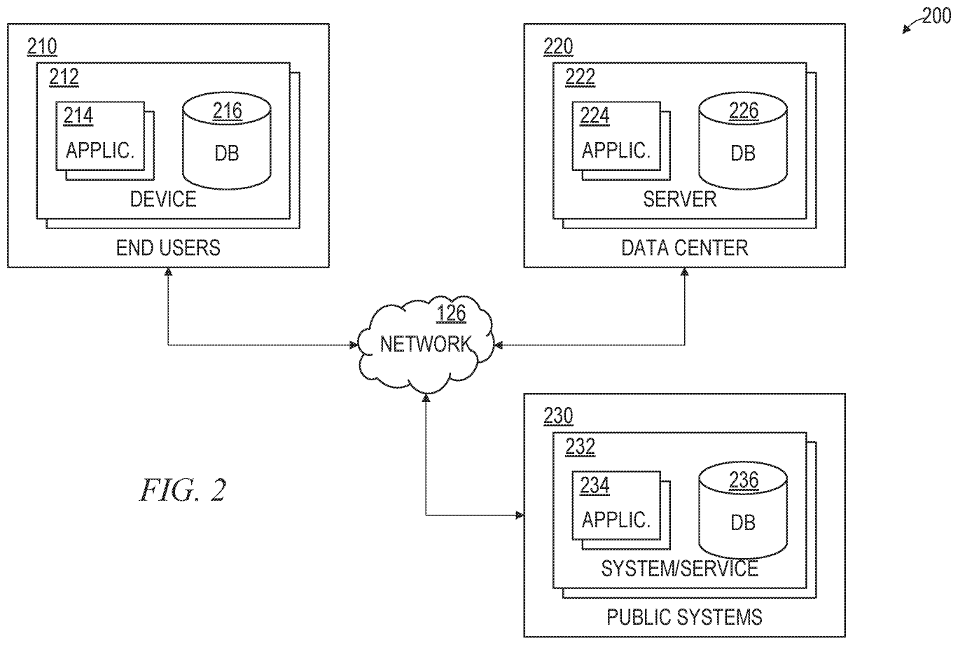

FIG. 2 is a block diagram of a distributed system 200 that may include a client-server architecture or cloud computing system. Distributed system 200 may have one or more end users 210. An end user 210 may have various end-user computing devices 212, which may be machines 100 as described above. The end-user computing devices 212 may comprise applications 214 that are either designed to execute in a stand-alone manner, or interact with other applications 214 located on the device 212 or accessible via the network 126. These devices 212 may also comprise a data store 216 that holds data locally, the data being potentially accessible by the local applications 214 or by remote applications.

The system 200 may also include one or more data centers 220. A data center 220 may be a server 222 or the like associated with a business entity that an end user 210 may interact with. The business entity may be a computer service provider, as may be the case for a cloud services provider, or it may be a consumer product or service provider, such as a retailer. The data center 220 may comprise one or more applications 224 and databases 226 that are designed to interface with the applications 214 and data stores 216 of end-user devices 212. Data centers 220 may represent facilities in different geographic locations where the servers 222 may be located. Each of the servers 222 may be in the form of a machine(s) 100.

The system 200 may also include available public systems 230 that comprise various systems or services 232, including applications 234 and their respective databases 236. Such applications 234 may include news and other information feeds, search engines, social media applications, and the like. The systems or services 232 may be provided as comprising a machine(s) 100.

The end-user devices 212, data center servers 222, and public systems 232 may be configured to connect with each other via the network 126, and access to the network by machines may be made via a common connection point or different connection points, e.g. a wireless connection point and a wired connection. Any combination of common or different connections points may be present, and any combination of wired and wireless connection points may be present as well. The network 126, end users 210, data centers 220, and public systems 230 may include network hardware such as routers, switches, load balancers and/or other network devices.

Other implementations of the distributed computing system 200 are also possible. For example, devices other than the client (end user) devices 212 and servers 222 shown may be included in the system 200. In an implementation, one or more additional servers may operate as a cloud infrastructure control, from which servers and/or clients of the cloud infrastructure are monitored, controlled and/or configured. For example, some or all of the techniques described herein may operate on these cloud infrastructure control servers. Alternatively, or in addition, some or all of the techniques described herein may operate on the servers 222.

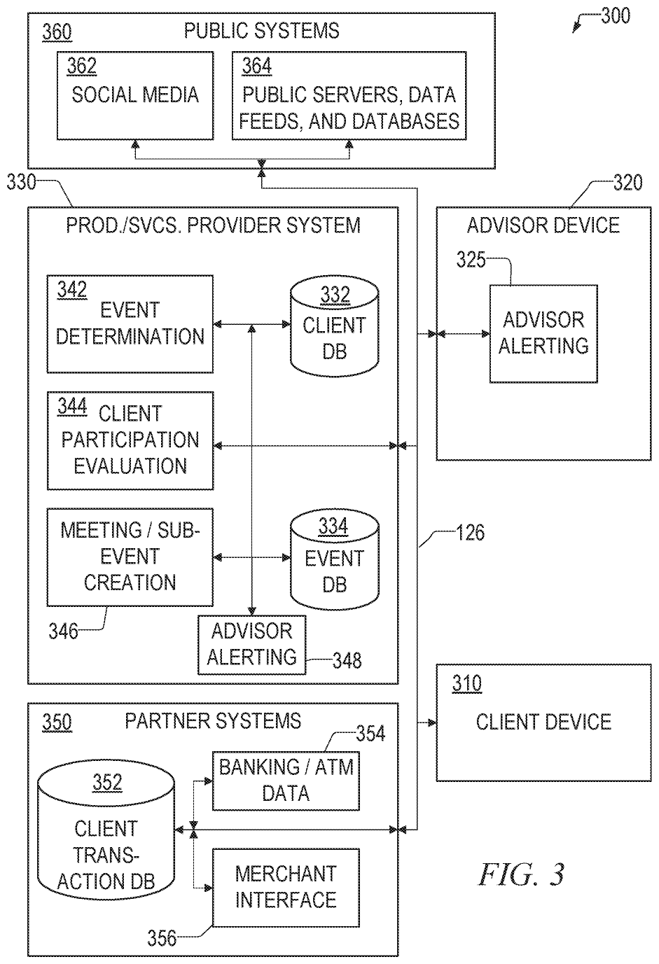

FIG. 3 is a block diagram of an example of a system 300 for an automatic detection of social group activities or events, as described herein. A primary relationship may be that between a product or services provider and their respective clients. Typically, the provider will appoint an agent as a primary point of contact with the client. It is generally presumed that a client has some mechanism allowing them to be contacted. In its most basic form, this may be a telephone—in a more typical situation, this mechanism would be a smart phone or some other processor-based network communications unit. In any case, the client device 310 described herein may be any of these devices, and may also be an end user device 212, as described above, that has a connection with the network 126.

An advisor may have a similar advisor device 320, which may be an end user device 212, connected to the network as well 126. The advisor device may further comprise an advisor alerting component 325, described in more detail below, that allows the advisor to be alerted when certain client activities take place.

A product/services provider system 330 with which the advisor is affiliated (e.g., an employee, agent, contractor, etc.) may comprise a data center 220 with one or more servers 222, as described above. The system may also comprise a client database 332, which may be a database 226 as described above, in which data about clients may be kept in a memory of the provider system 330. This information may include for, e.g., a financial services provider, contact information-such as address, telephone number, and email address-demographic information, account information, investment preferences, an agent's personal notes about the client, such as birthdays, anniversaries, spouse, children, hobbies, etc. The provider system 330 may also comprise an event database 334, which may also be a database 226 as described above, in which information about past, current, and future events is maintained.

The provider system may further comprise an event determination component 342 that may be utilized to gather information related to local, regional, national, or international events. Such information may comprise an event name, location, timing, nature of the event (e.g., subject matter, such as a concert, sporting event, etc.).

This component may determine an occurrence of an event by collecting topical information (e.g., by collecting information about a particular baseball team, a particular theatre, a particular charitable organization, etc.). Such topical information may be obtained from partner systems 350 and/or public systems 360, discussed in more detail below. An instance of an event based on the topical information may be detected from client data within the client database 332, data provided by partner systems 350 (e.g., transaction data showing a client purchase of tickets to a baseball game, a particular play, or tickets to a charity event on particular date). Additionally, the determination of an event may be “learned” from transaction data using artificial intelligence techniques (e.g., natural language processing, machine learning, etc.). Event determination information may also be entered by an advisor (e.g., an advisor is at or planning to go to a particular event and wants to know which of her clients will be, or are, there). Also, an instance of an event may be determined by monitoring information from the public systems 360. A determination of an event may also be determined from or based on non-public financial transaction data received at a network interface of the system, discussed in more detail below. Information that is collected may be stored in the event database 334.

The event determination component 342 might be a part of an event processing component (not separately shown). If adequate information (e.g., identification, location, and time) is received by the provider system 330 related to an event over the network 126, then the event information might simply be stored in the event database 334, possibly with some reformatting. If not, then the event processing component may rely upon the event determination component 342 in the manner described above.

With the event determination component 342 having determined the occurrence and location of an event, the next feature is the determination of which clients will be participating in the event. A client participation evaluation component 344 thus may be provided to determine which clients are at, or are likely to be going to, the event. The system 330 may scan client data in the client database 332 to detect client participation. The client database 332 may also include non-public financial transaction data obtained from a partner system 350 over a partner system interface, such as transaction or purchase data (such as a purchase of a ticket to the event) from a client transaction database 352, or banking/automated teller machine (ATM) data 354 (such as an ATM withdrawal indication at the event). This non-public financial transaction data may include data from a credit or debit card transaction, an ATM transaction, or merchant transaction data.

The data in the client database 332 may also include data obtained from public systems 360 over the network 126, including social media 362 (e.g., data from client comments related to the event on Facebook, Twitter, etc.), public servers, data feeds, and databases 364 (such as venue addresses, etc.), and even information obtained from the client device 310 itself, such as GPS data (the GPS data for a client may provide information that a client is at a particular location that coincides with an event location). Any of the information obtained and stored in the client database 332 and the event database 334 may be combined to make a determination that a particular client is, or is likely to be, participating in a particular event. The notion of “likely” to be participating or attending should be understood to be based on a probabilistic assessment in which some estimate of a probability is calculated. For example, a predefined criterion might indicate that, if there is a greater than 50% probability that one may be attending an event, then that person is “likely” to attend. Factors in determining this may be based on historical data, heuristics, and the like. In this way, the term “likely” may be definitively determined with respect to attendance.

The client participation evaluation component 344 may store the indication of likely client attendance at an event in the client database 332, in the event database 334, or some other database (and any or all of these), and may include or relate a client identifier and an event identifier, that links to other information associated with the client (including their advisor) and the event, respectively.

Both the event determination component 342 and the client participation evaluation component 344 may utilize learning systems, such as neural networks and artificial intelligence features, applying weighted factor analyses that may be modified over time. Such systems are not perfect at prediction, and thus it may be desirable to include some form of a verification component (either manual or automatic) that may try to minimize the occurrence of false positive indications. Likelihood factors may also be provided to the advisor to assist the advisor in decision making. For example, if a client uses an ATM machine two blocks from a sports arena and the client lives fifteen miles from the sports arena, there may be a 95% certainty that the client is attending a sporting event taking place at the sports arena. However, that certainty may only be 20% if the client lives 300 yards from the ATM machine.

Any of the client information stored in the client database 332 should be obtained and used consistent with applicable laws and agreements. For example, the client may opt in to a program that allows all or certain of their transaction data to be collected and used for marketing purposes or for purposes of being notified of provider events that the client may be interested in. The authorization may be by physically signing forms or providing an indication when installing an application on their device 310. Furthermore, the clients may specify, in particular, what types of information may be used, and what types of events that they are interested in being notified about.

Once the clients at, or likely to be at, the event are determined, an advisor alerting component may be provided so that one or more appropriate advisors may be alerted with an indication as to which clients are at or likely to be at a particular event. As shown in FIG. 3, a portion of the advisor alerting component 348 may reside on the provider system 330 that utilizes the output of the client participation evaluation component 344 and provide information about client participation at an event to an advisor alerting component 325 that resides on the advisor device 320. This alerting may take place via a relatively simple mechanism such as an alert message sent via email, or be in a form of a more customized application. Alerts may be sent to more than one advisor and/or a customer service representative.

A notification algorithm may be provided that determines who should be notified based on a particular client or set of clients who may be attending an event. The notification algorithm may further use filtering mechanisms that may be set up, for example, by the advisor using a user interface of an application running on her advisor device 320 or by the advisor or other person using an interface to an application on the provider system 330. The filtering mechanisms may, for example, be created as a set of rules and be represented as a text file that is interpreted by a processor, as programming logic, or other logic representation format. The filtering mechanisms may, for example, ensure that an advisor does not get an alert for someone who is not his direct client (or perhaps, in case the client's advisor is unavailable and the current advisor has been designated as a backup). The filtering mechanism may establish alert criteria, such as not to send an alert for an event greater than ten miles away unless at least five clients are likely to be in attendance. Any form of filtering may be utilized.

In a more sophisticated model, a generation of an alert list may take into account prospective products or services a client may be interested in and alert others who might specialize in such products or services. Alerts may also be provided to product specialists or those involved in the provider's marketing strategy, or individuals from the provider or partner systems with whom the client has an established relationship.

Once alerted, the advisor(s) may chose an appropriate response activity. The response activity may be based on a count of clients who are at the event, or on various attributes of clients at the event, such as portfolio value, longevity of the client relationship, and/or potential for future business. One such response activity may be an individual client contact, which might include one or more advisors making contact with the client and inviting them for a drink or food, or to meet at a particular location at the event. Such contact may be in various forms, such as a telephone call, email, or text message to the client via the client device 310. Another type of response may be to prepare a more formalized sub-event that multiple clients may be invited to attend at the event or afterwards. For such a sub-event, advisors may be able to alert all clients attending the event to attend the sub-event, using one of the previously mentioned contact methods.

A meeting or sub-event creation component 346, which may be a form of a meet-up application, may be included in the provider system 330 to assist in the creation of a sub-event and notifying potential or existing clients at an event of the details related to the sub-event (a corresponding component (not shown) may also be provided on the advisor device 320 as well).

The meeting or sub-event creation component 346 may designate a venue based on, for example, predefined rules which may be set up, for example, by the advisor using a user interface of an application running on her advisor device 320 or by the advisor or other person using an interface to an application on the provider system 330. The filtering mechanisms may, for example, be created as a set of rules and be represented as a text file that is interpreted by a processor, as programming logic, or other logic representation format. The venue may be a particular area, restaurant, bar, or other nearby venue as a place to meet, or it may leverage other tools, such as attempting to make restaurant reservations (e.g., through OpenTable), reserving a provider-owned box at a sports arena, etc. The meeting or sub-event creation component may use algorithms to try to minimize a distance which must be traveled by potential participants, or to take into account other factors, such as a likely duration, cost, and known client likes and dislikes.

It is also possible that the client device 310 may contain an application (not shown) that alerts them of any sub-events that are created by, e.g., the sub-event creation component 346. The advisor (possibly with the aid of the sub-event creation component 346) may send out an invitation to all client participants at the event, or some subset of the client participants, possibly based on information stored in the client database 332. In one configuration, the sub-event creation component 346 does not need to determine if a client is attending the event or not—it may simply send an invitation to clients meeting certain criteria (e.g., live within a particular zip code area) indicating the occurrence of the sub-event (e.g., “we are having this <sub-event> if you're available and interested in stopping by”).

Also, the sub-event creation component 346 may create events available to the general public, but provide some sort of exclusivity for the clients (or possibly prospective clients). For example, the provider is an official sponsor of major league soccer (MLS), giving the provider opportunities during the MLS start weekend to allow invitees to meet specific players sponsored by the provider. The provider may have a Twitter account via which anyone may follow the provider—and the provider may tweet to the general public about meeting the sponsored players. However, the sub-event creation component 346 may also allow clients exclusive access to the sponsored players, e.g., an hour in advance. Thus, for clients who are already connected to the provider via social media, this client information may be paired with existing client information to create an enhanced experience.

In order to enhance the effectiveness of advisors meeting with clients, relevant client data, such as family member names and other client summary data obtained from the client database 332 may be provided to the advisor on the advisor device 320.

Each of the components described above may be used together, individually, or in any combination. For example, instead of the advisor alerting component 348 notifying the advisor of client attendance at an event, the advisor may simply notice the client's attendance from a Facebook posting. The advisor may then utilize the meeting creation component 346 to try to arrange something with the client. Alternately, the advisor may receive an alert from the advisor alerting component 348, and then simply call the client instead of using the meeting creation component 346.

Partner systems 350 may provide access, with client permission, to information that may assist the provider system 330, such as access to client transaction information from the client transaction database 352 or use of banking/ATM machine data 354. Also, data for client purchases with a merchant may be obtained via a merchant interface 356. Credit/debit card purchase information may be provided via the merchant interface 356 itself, or, if the credit/debit card is associated with, e.g., a particular bank, the bank may notify the provider system 330 when it detects a use of the card. In one configuration, the client may provide information about attendance at an event directly to the advisor or to the provider system using, e.g., the client device 310.

The provider system 330 may operate on a larger level as well. For example, in a large city, a huge expo may be happening at which the system determines that at least two hundred clients will likely attend and the city has sixty advisors. The provider system may, independent of any particular advisor, create a large-scale sub-event and then notify advisors and clients alike of the existence of the sub-event. Any of the events created may take into account situational factors in the type of events created. For example, if the event is a marathon on a hot day, an event may be created that is simply “stop by our tent at the halfway point and get a free bottle of water by showing us your credit card”.

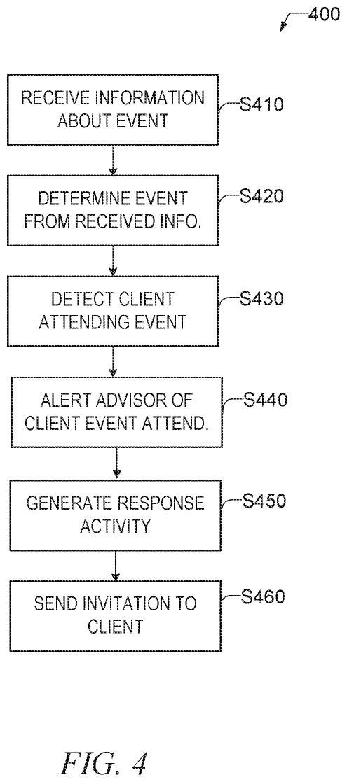

FIG. 4 is a flowchart illustrating a process for using the system described above. This process may be performed on a machine 100 that executes instructions 124 stored in the main memory 104 of the computer. Such instructions may originate, for example, from instructions 124 of the machine readable medium 122 of the storage device 116 that is associated with this machine 100 or another accessible over the network 126. According to the process 400, in operation S410, information about the event may be received from a wide variety of sources, including publicly available information and private information (with permission from the client). Based on the information, in operation S420, an event and its associated information such as location, time, nature of the event, etc. may be determined. In operation S430, client attendance at the event may be determined based on a wide variety of sources, including publicly available information and private information. Although the flowchart illustrates detecting client attendance at an event to occur sequentially after the existence of the event is determined, these may occur simultaneously—for example, when the existence of the event is determined based on, e.g., a ticket purchase by the client to the event.

In operation S440, an advisor is alerted to the client attendance at the event, and some form of a response activity is generated in operation S450, which may be some form of a meeting. Once the response activity is created, in operation S450, an invitation may be sent to the client. In simple cases, the generation of the response activity and the sending of an invitation to the client may occur in a single step, such as when the event is a simple advisor-client meeting and the invitation is an email or calendar request.

The following describes an example use and variations in which the provider system 330 is utilized and demonstrates an interaction of the client device 310, advisor device 320, provider system 330, a partner system 350, and public systems 360 that communicate over the network. A client has provided authorization for a financial services provider to access transaction, banking, and ATM transaction data obtained by a partner bank of the financial services provider for the purpose of keeping the client in contact and notifying the client of events and promotions of the financial services provider. This may be done by filling out forms that are subsequently entered into the client database 332, or may be done by a client using her device 310 to interact via the network 126 with an authorization program on the provider system 330. The authorization may be stored in a text file or in a data file that indicates the different types of permitted use for information within the client database 332 and/or from partner systems 350.

The client uses an ATM card outside of a sports arena on a particular day. The ATM transaction data is forwarded over the network 126 and is received by a computer of the bank (partner system 350) at a network interface. This data is then forwarded on to a computer in the financial services provider system 330 that logs the data in a client record in the client database 332. The event determination unit 342 determines from the public systems 360, based on input received over the network 126, such as information obtained from a bot that accesses a home-team web page, that there is a home-team baseball game that day, and this event is stored in the event database 334. The client participation evaluation component 344 may deduce that there is a high likelihood that this client is attending the home-team baseball game.

The advisor alerting component 348 of the provider system 330 sends the alert to the advisor's device 320 over the network 126, and the advisor is made aware of the likely attendance of her client at the game by, for example, message or email transmitted to the advisor's device 320. The advisor decides to call the client to see if the client would be interested in grabbing a bite to eat after the game, but before she can do this, she is notified on her device 320 that four other clients are also likely to be attending the game as well. The advisor knows that the provider maintains a club area by accessing other provider data (not shown) on the provider system 330 at the arena that may be available for the event, so she utilizes the sub-event creation component 346 to check on the availability of this club area (e.g., via a reservation application on the provider system). The availability is confirmed, and so she uses the sub-event creation component 346 to reserve the club, arrange for service, and send out emails to the clients attending the event and notifying them of the availability of stopping by the club area for free drinks.

Although not formally a “meet-up”, it may also be possible that indications of interests may be used from the client database 332 to enable clients to participate in events that they might not otherwise be able to participate in. For example, if an advisor has tickets to a sold out Paul McCarthy concert and then determines that she cannot attend the concert, the advisor may make use of the client preferences in the client database 332, which may be stored in a hobbies/interests record maintained by the advisor, and may be able to offer those tickets to a client who might likely be interested by sending an email or initiating some other form of contact over the network 126.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products.

Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like. The code may also be intangibly stored on one or more non-transitory and non-volatile computer readable media, such as those described above. In these cases, instructions resident on the media are read and executed by a processor to perform various functions.

The above description is intended to be illustrative, and not restrictive. For example, the above-described examples (or one or more aspects/configurations thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it should not be used to interpret or limit the scope or meaning of the claims.

Also, in the above Detailed Description, various features may be grouped together to streamline the disclosure. However, the claims cannot set forth every feature disclosed herein, as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the claims, along with the full scope of equivalents to which such claims are entitled.

1. A computer-implemented method for detecting a social group activity, comprising:
receiving, at a network interface of a computer-based system, public topical information and non-public financial transaction data;
determining an occurrence of an event and event location based on the public topical information and the non-public financial transaction data;
receiving financial transaction data associated with a first person, the financial transaction data including a transaction at an automatic teller machine, and wherein the financial transaction data includes location data for the transaction at the automatic teller machine;
creating person-event data by determining, with a neural network using the location data of the financial transaction data of the first person, a probability that the first person is attending the event, wherein the neural network is trained with locations of automatic teller machine transactions and event data, and wherein the first person has not formally committed to attending the event;
determining the first person is likely to attend the event based on the probability exceeding a predefined criterion;
in response to determining the first person is likely to attend the event, transmitting, to a communication device of a second person over the network interface, first person information related to the person-event data, wherein the second person has not formally committed to attending the event;
generating response activity information for a response activity event, wherein the response activity event is based on the person-event data with the response activity information including a response activity location based on the event location; and
transmitting, to a communication device of the first person over the network interface, an invitation to the response activity event.

2. The method of claim 1, wherein the financial transaction data includes non-public financial transaction data received at the network interface.

3. The method of claim 2, wherein the system comprises a memory comprising authorization from the first person to access the non-public financial transaction data.

4. The method of claim 2, wherein the non-public financial transaction data is at least one of credit or debit card transaction data and merchant transaction data.

5. The method of claim 1, wherein the financial transaction data includes public systems data received at the network interface.

6. The method of claim 1, wherein the first person information includes archived first person data stored in a memory of the system prior to receiving the public topical information and the non-public financial transaction data

7. The method of claim 1, wherein the financial transaction data is associated with a first plurality of persons and the response activity event is further determined based in part on at least one of:
a) a count of the first plurality of persons; and
b) attributes of the first plurality of persons.

8. The method of claim 7, wherein:
the transmitting to a second person comprises transmitting to a second plurality of persons; and
the second plurality of persons are selected based on attributes of the first plurality of persons.

9. The method of claim 1, wherein the transmitting to a second person comprises transmitting to a second plurality of persons.

10. The method of claim 1, further comprising:
receiving a response to the invitation from the first person; and
transmitting the received response to the second person.

11. The method of claim 1, wherein the response activity event is a potential meeting between the first person and the second person.

12. A system comprising:
at least one hardware processor;
a network interface connected to the at least one hardware processor that is connected to a network via which information related to events, clients, and advisors is communicated;
a non-volatile memory connected to the at least one hardware processor and the network interface comprising event data and client data, wherein the non-volatile memory includes instructions that, when executed by the at least one hardware processor, cause the at least one hardware processor to:
receive public topical information and non-public financial transaction data;
determine an occurrence of an event and event information based on the public topical information and the non-public financial transaction data;
receive financial transaction data associated with a first person, the financial transaction data including a transaction at an automatic teller machine, and wherein the financial transaction data includes location data for the transaction at the automatic teller machine;
create person-event data by determining, with a neural network using the location data of the financial transaction data of the first person, a probability that the first person is attending the event to create person-event data, wherein the neural network is trained with locations of automatic teller machine transactions and event data, and wherein the first person has not formally committed to attending the event;
determine the first person is likely to attend the event based on the probability exceeding a predefined criterion;
in response to determining the first person is likely to attend the event, transmit to a communication device of a second person over the network interface, first person information related to the person-event data, wherein the second person has not formally committed to attending the event; and
generate response activity information for a response activity event, wherein the response activity event is based on the person-event data with the response activity information including a response activity location based on the event location; and
transmit, to a communication device of the first person over the network interface, an invitation to the response activity event.

13. The system of claim 12, wherein the network interface comprises a partner system interface via which non-public financial transaction data is received.

14. The system of claim 13, wherein the non-public financial transaction data is at least one of credit or debit card transaction data and merchant transaction data.

15. The system of claim 13, wherein the network interface further comprises a public system interface via which publicly available information is received that is combined with the non-public financial transaction data.

16. The system of claim 12, wherein the first person information includes archived first person data stored in a memory of the system prior to receiving the public topical information and the non-public financial transaction data

17. The system of claim 12, wherein the financial transaction data is associated with a first plurality of persons and the response activity event is further determined based in part on at least one of:
a) a count of the first plurality of persons; and
b) attributes of the first plurality of persons.

18. The system of claim 17, further comprising instructions to:
transmit to a second plurality of persons, wherein the second plurality of persons are selected based on attributes of the first plurality of persons.

19. The system of claim 12, further comprising instructions to:
receive a response to the invitation from the first person; and
transmit the received response to the second person.

20. A non-transitory computer-readable storage medium, the computer-readable storage medium including instructions that when executed by a computer, cause the computer to perform operations of:
receiving, at a network interface of a computer-based system, public topical information and non-public financial transaction data;
determining an occurrence of an event and event location based on the public topical information and the non-public financial transaction data;
processing, using a processor of the computer based system, and storing, in a memory of the computer based system, the event information;
receiving financial transaction data associated with a first person, the financial transaction data including a transaction at an automatic teller machine, and wherein the financial transaction data includes location data for the transaction at the automatic teller machine;
creating person-event data by determining, with a neural network using the location data of the financial transaction data of the first person, a probability that the first person is attending the event to create person-event data, wherein the neural network is trained with locations of automatic teller machine transactions and event data, and wherein the first person has not formally committed to attending the event;
determining the first person is likely to attend the event based on the probability exceeding a predefined criterion;
in response to determining the first person is likely to attend the event, transmitting, to a communication device of a second person over the network interface, first person information related to the person-event data, wherein the second person has not formally committed to attending the event;
generating response activity information for a response activity event, wherein the response activity event is based on the person-event data with the response activity information including a response activity location based on the event location; and
transmitting, to a communication device of the first person over the network interface, an invitation to the response activity event.
